(19) United States
(12) Patent Application Publication
(10) Pub. No.: US 2019/0383098 A1
(43) Pub. Date: Dec. 19, 2019

(54) HORIZONTALLY EXTENDABLE LADDER

(71) Applicant: Shou-I SUN, La Palma, CA (US)

(72) Inventor: Shou-I SUN, La Palma, CA (US)

(21) Appl. No.: 16/008,633

(22) Filed: Jun. 14, 2018

(51) Int. Cl. E06C 1/383; E06C 1/08; E06C 1/22

(52) U.S. Cl. CPC E06C 1/383; E06C 7/082; E06C 1/22; E06C 1/08

(57) ABSTRACT

A horizontal extendable ladder is revealed. The horizontally extendable ladder includes at least three rails and a plurality of rungs disposed between the two adjacent rails. The three rails are set vertically while the rungs are equally spaced and arranged horizontally between the two adjacent rails from top to bottom to form at least two ladder frames. Each of two ends of the rung is arranged with a first pivot shaft that is pivotally connected to the rail. Thereby the rungs can be rotated synchronously between the two adjacent rails for horizontal retraction or extension of the ladder. The ladder is used more efficiently.

### BACKGROUND OF THE INVENTION

### Field of the Invention

The present invention relates to an extension ladder, especially to a horizontally extendable ladder that includes at least two ladder frames each of which consists of two rails and a plurality of rungs arranged between the two rails. The rungs between the two adjacent rails can be rotated synchronously for horizontal extension or retraction of the ladder.

A ladder is a useful tool with many applications in our daily lives. It allows users to work at height such as ceiling decoration, painting, change of lighting, storage of object, etc. Besides leaning ladders and A-shaped ladders, ladders types further include foldable ladders or telescoping ladders. The A shaped ladders are forms by two ladders whose tops are connected while the bottoms are apart and against ground for supporting. However, the ladder available now includes only a single ladder frame (whose width is about the same with the width of the rung) so that only one person can climb the ladder. The operation range/width of the user climbing the ladder to a certain height is limited. Once the work area at height is quite large, users need to set up the ladder and get access to a part of the work area. Then the users need to shift the ladder several times and get access to the rest part of the work area for completing the operation. It takes time for users to go up and down the ladder during the operation. Thereby not only the operation time is increased, the user also consumes much physical strength. Moreover, the ladder only allows one person to climb. When at least two workers need to climb to the height at the same time (such as for lifting an object), they need to use two ladders arranged in parallel respectively. Thus the ladder cause trouble to the user and the efficiency of the ladder is affected negatively.

### SUMMARY OF THE INVENTION

Therefore it is a primary object of the present invention to provide a horizontally extendable ladder that includes at least three rails and a plurality of rungs. The three rails are set vertically while the rungs are equally spaced and arranged horizontally between the two adjacent rails from top to bottom to form at least two ladder frames. Each of two ends of the rung is arranged with a first pivot shaft that is pivotally connected to the rail. Thereby the rungs can be rotated synchronously between the two adjacent rails for horizontal retraction or extension of the ladder. Thereby the problems of the conventional ladder such as only allowing one person to use and the limited horizontal operation range can be solved. The ladder can be used more efficiently.

In order to achieve the above object, a horizontally extendable ladder according to the present invention includes at least two ladder frames formed by at least three rails. The three rails consist of two outer rails and one middle rail set between the two outer rails. A plurality of rungs is equally spaced and arranged horizontally between the two adjacent rails from top to bottom. The two adjacent rails and the rungs therebetween form one ladder frame. A first pivot shaft arranged at each of two ends of the rung is pivotally connected to the rail so that the rungs can be rotated synchronously between the two adjacent rails. Thereby the rungs of the ladder frame can be rotated and folded between the two adjacent rails to form a first collapsed state by the first pivot shafts on the two ends thereof While the rungs of the respective ladder frame are in the first collapsed state, the two adjacent rails can be moved close to each other and held together so as to reduce the width and the area of the respective ladder frame. Each rung of the respective ladder frame are rotated and extended between the two adjacent rails by the first pivot shafts on the two ends thereof to become an extended state when the two adjacent rails in the first collapsed state are extended horizontally. The at least two ladder frames are extended synchronously to form the horizontally extendable ladder in an extended state with the extended width and area of the two ladder frames. Or only one of the ladder frames is selected and opened fully to form the horizontally extendable ladder in the extended state and having the width and area of the single frame.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing a front view of an embodiment extended fully according to the present invention;

FIG. 2 is a schematic drawing showing a front view of an embodiment partially retracted according to the present invention;

FIG. 3 is a schematic drawing showing a front view of the embodiment in FIG. 2 retracted completely according to the present invention;

FIG. 4 is a schematic drawing showing a front view of another embodiment extended fully according to the present invention;

FIG. 5 is a schematic drawing showing a front view of the embodiment in FIG. 4 partially retracted according to the present invention;

FIG. 6 is a schematic drawing showing a front view of the embodiment in FIG. 4 retracted completely according to the present invention;

FIG. 7 is a schematic drawing showing a front view of a further embodiment extended fully according to the present invention;

FIG. 8 is a schematic drawing showing a front view of the embodiment in FIG. 7 partially retracted according to the present invention;

FIG. 9 is a schematic drawing showing a front view of the embodiment in FIG. 7 retracted completely according to the present invention;

FIG. 10 is a schematic drawing showing a front view of a further embodiment extended fully according to the present invention;

FIG. 11 is a schematic drawing showing a front view of the embodiment in FIG. 10 partially retracted according to the present invention;

FIG. 12 is a schematic drawing showing a front view of the embodiment in FIG. 10 retracted completely according to the present invention.

FIG. 13 is a schematic drawing showing a top view of the embodiments in FIG. 1 and FIG. 4 according to the present invention;

FIG. 14 is a top plan view of the embodiments in FIG. 7 and FIG. 10 according to the present invention;

FIG. 15 is a schematic drawing showing the embodiment in FIG. 1 placed against a wall surface according to the present invention;

FIG. 16 is a schematic drawing showing the embodiment in FIG. 7 leaned against a wall surface according to the present invention;

FIG. 17 is a perspective view of an embodiment of an A-shaped ladder according to the present invention;

FIG. 18 is a perspective view of another embodiment of a A-shaped ladder according to the present invention;

FIG. 19 is a partial enlarged view of the embodiment in FIG. 7 according to the present invention;

FIG. 20 is a partial enlarged view of the embodiment in FIG. 8 according to the present invention;

FIG. 21 is a partial enlarged view of a section of an embodiment of a rung according to the present invention;

FIG. 22 is schematic drawing showing the rails in the embodiment of Fig. 21 inclined and set on the ground according to the present invention;

FIG. 23 is a partial enlarged view of a section of another embodiment of a rung according to the present invention;

FIG. 24 is a left side view of the rung in FIG. 23 according to the present invention;

FIG. 25 is a right side view of the rung in FIG. 23 according to the present invention;

FIG. 26 is schematic drawing showing the rails in the embodiment of FIG. 23 inclined and set on the ground according to the present invention;

FIG. 27 is a left side view of the rung in FIG. 26 according to the present invention;

FIG. 28 is a right side view of the rung in FIG. 26 according to the present invention;

### DETAILED DESCRIPTION OF THE PREFFERED EMBODIMENT

A common ladder includes a leaning ladder, an A-shaped ladder, etc. The present invention features on the horizontal extension of the ladder.

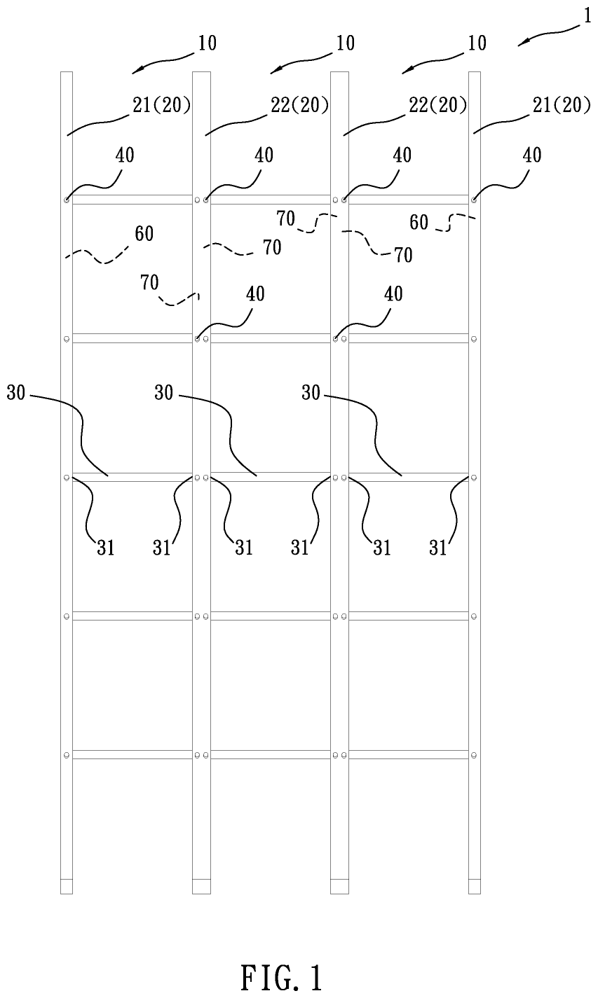

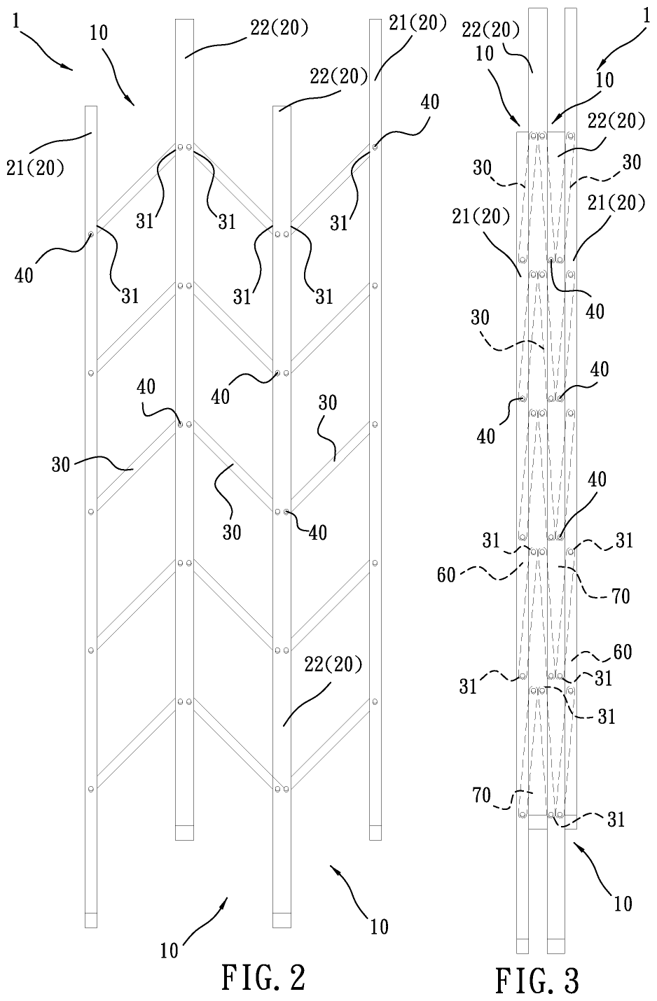

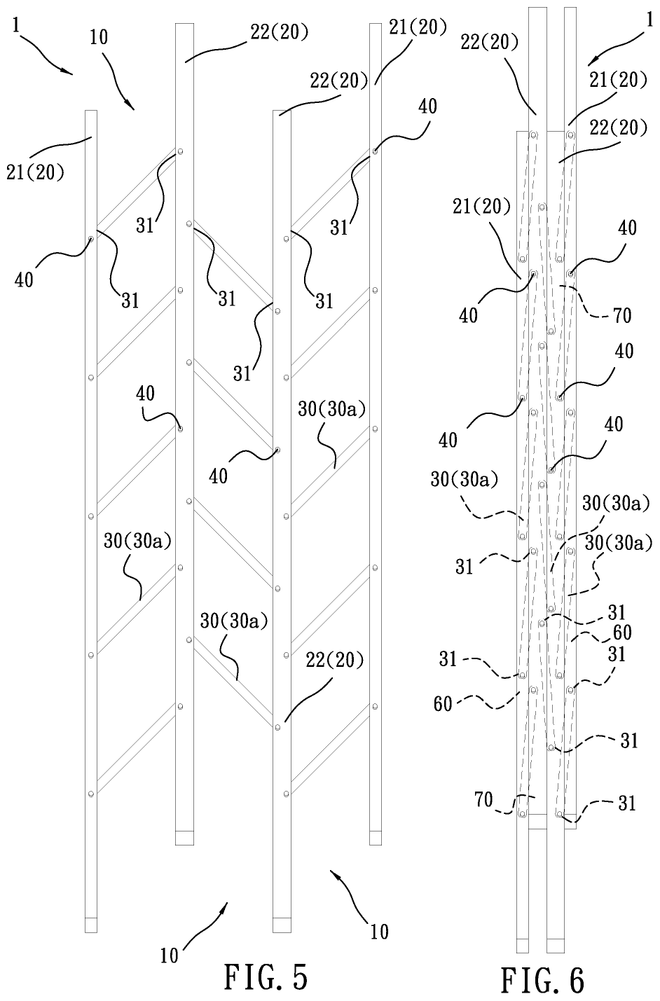

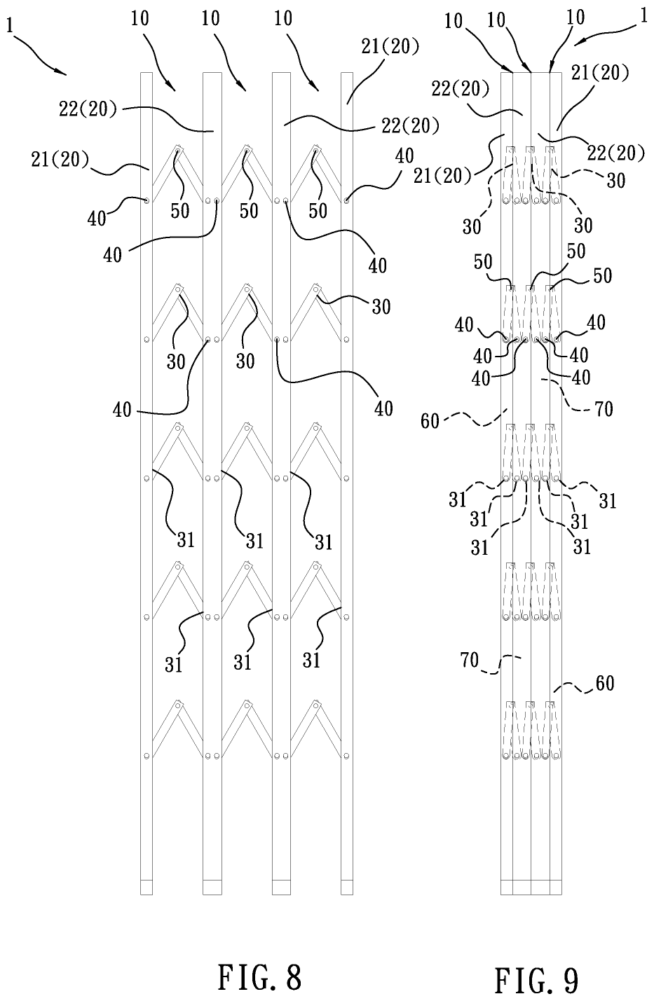

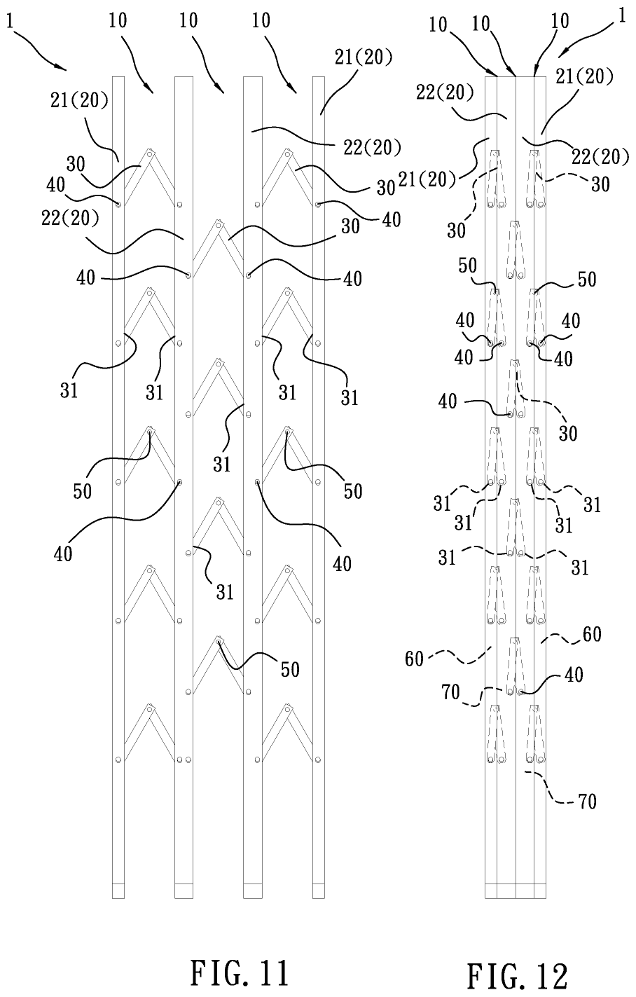

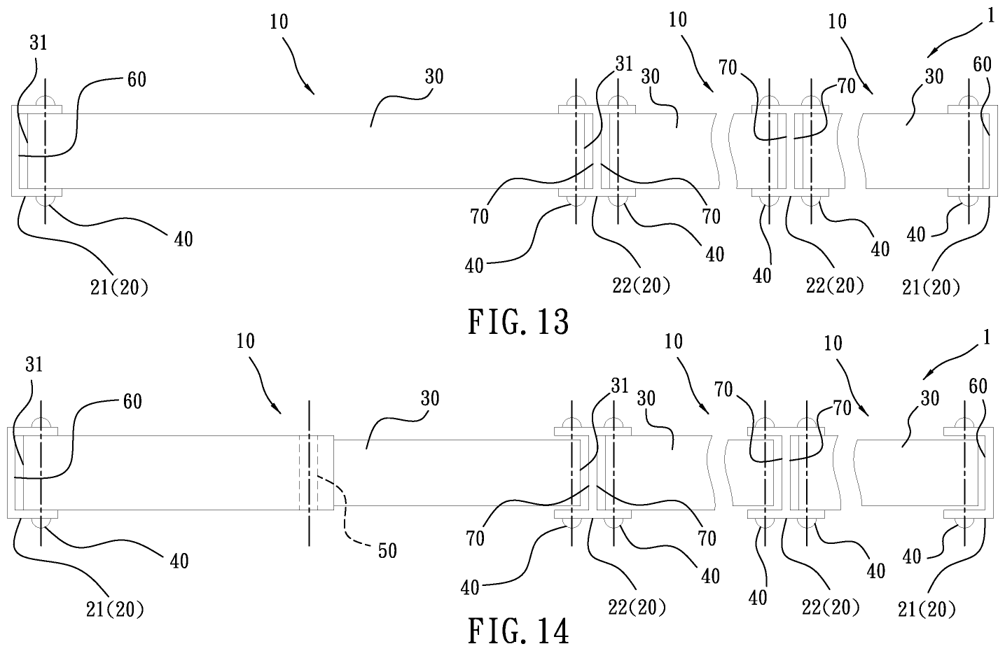

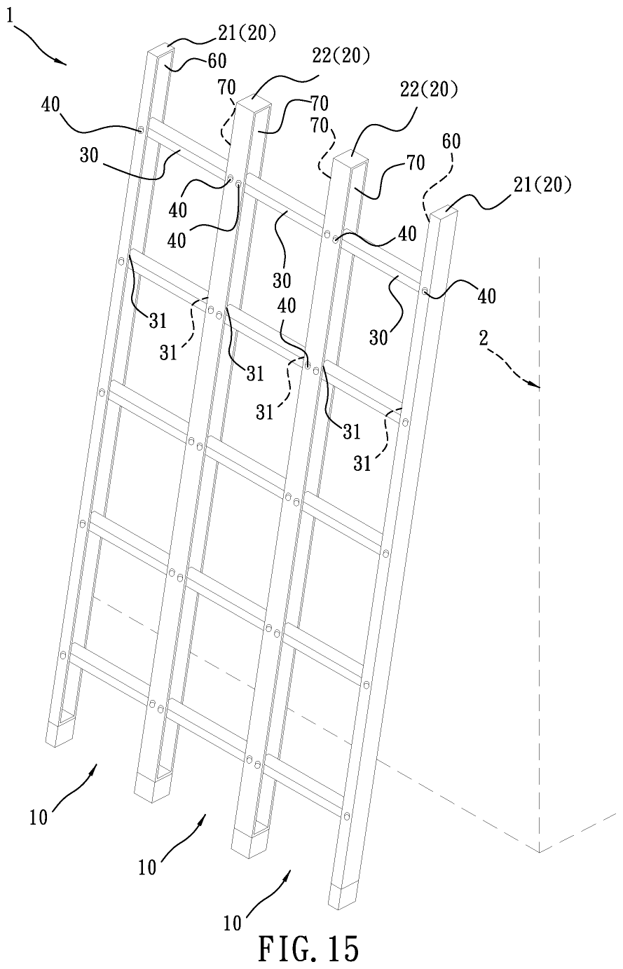

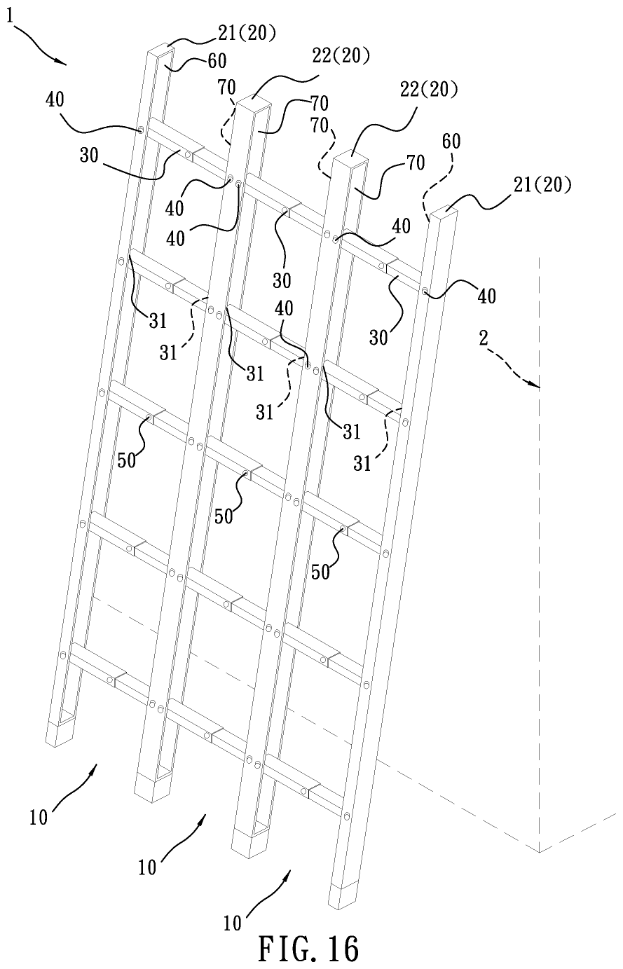

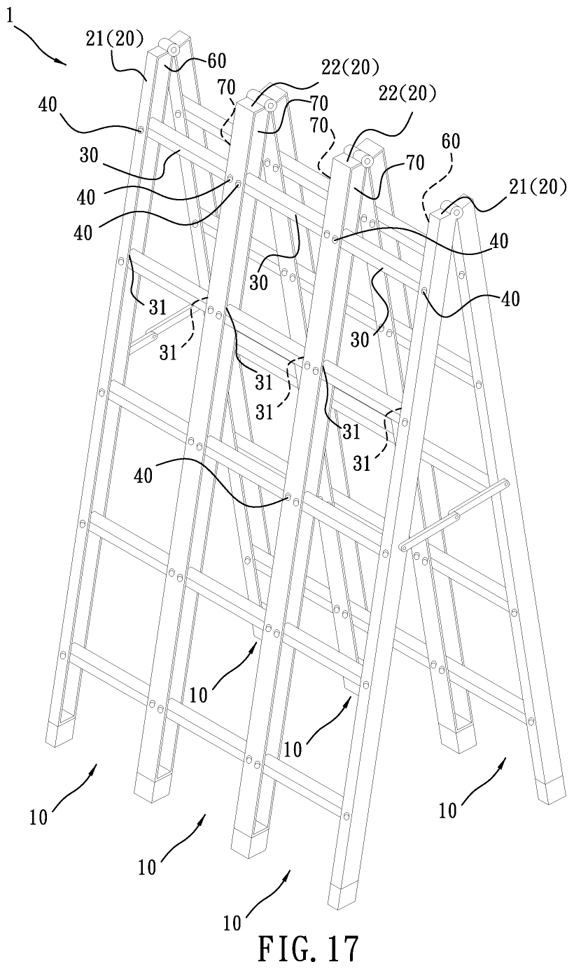

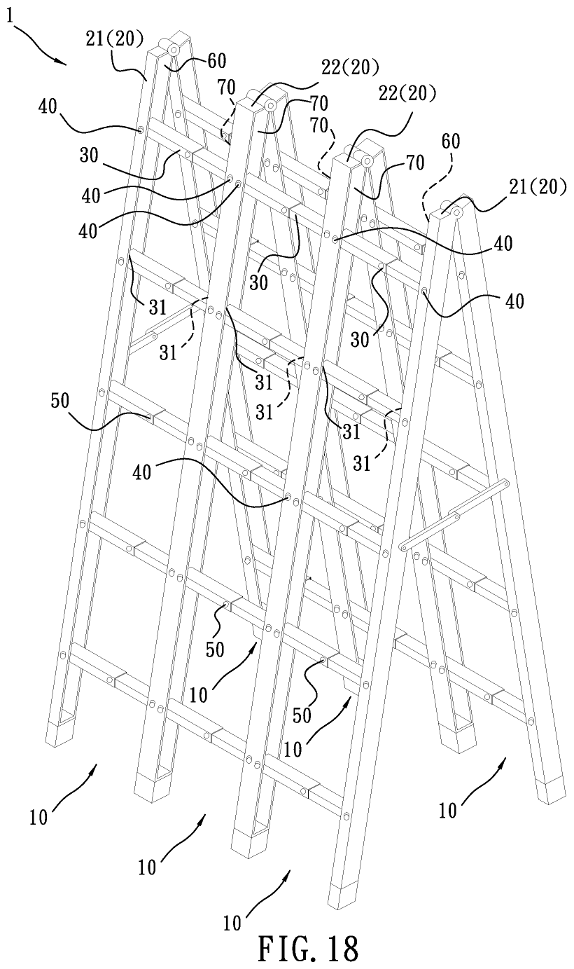

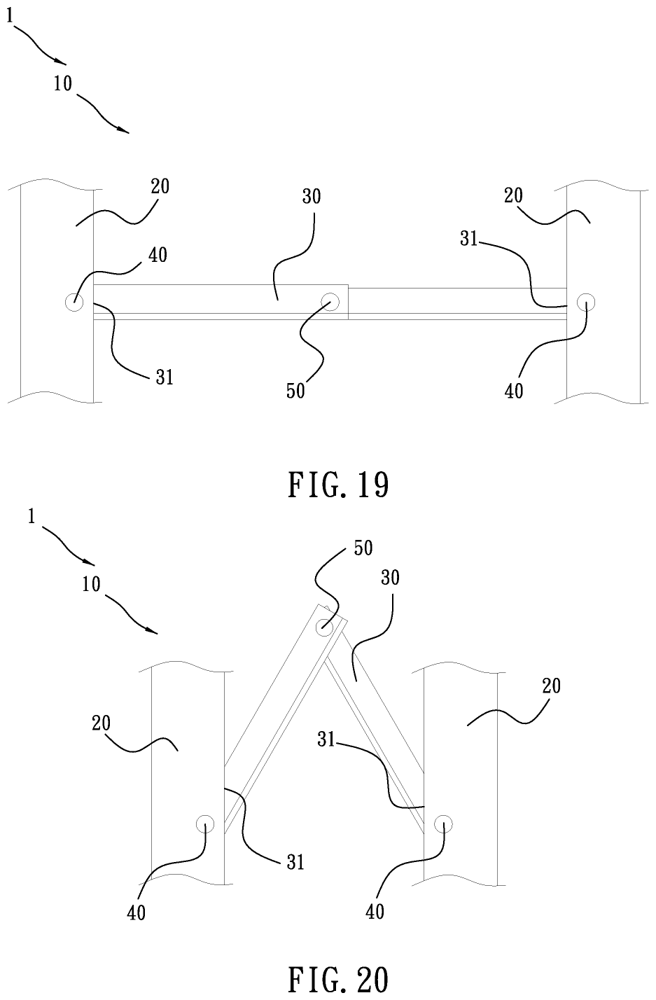

Refer to FIG. 1-18, a horizontally extendable ladder 1 according to the present invention includes at least two ladder frames 10. The at least two ladder frames 10 consist of at least three rails 20 and a plurality of rungs 30. The three rails 20 are arranged vertically and are composed of two outer rails 21 and at least one middle rail 22 set between the two outer rails 21. The rungs 30 are equally spaced and arranged horizontally between the two adjacent rails 20 from top to bottom. In the embodiments shown in figures, there are three ladder frames 10 included in the horizontally extendable ladder 1. There are four rails 20 formed by two outer rails 21 and two middle rails 22. Each of the two ends 31 of the rung 30 is arranged with a first pivot shaft 40 that is pivotally connected to the rail 20. Thereby the rungs 30 can be rotated synchronously between the two adjacent rails 20, as shown in FIG. 2, FIG. 5, FIG. 8 and FIG. 11.

The rung 30 of the respective ladder frame 10 can be rotated and folded between the two adjacent rails 20 by the first pivot shafts 40 of the two ends 31 to become a first collapsed state, as shown in FIG. 3 and FIG. 6. Now the two adjacent rails 20 can be moved close to each other and held together so that the width and the area of each ladder frame 10 are minimized. The volume transported is also reduced.

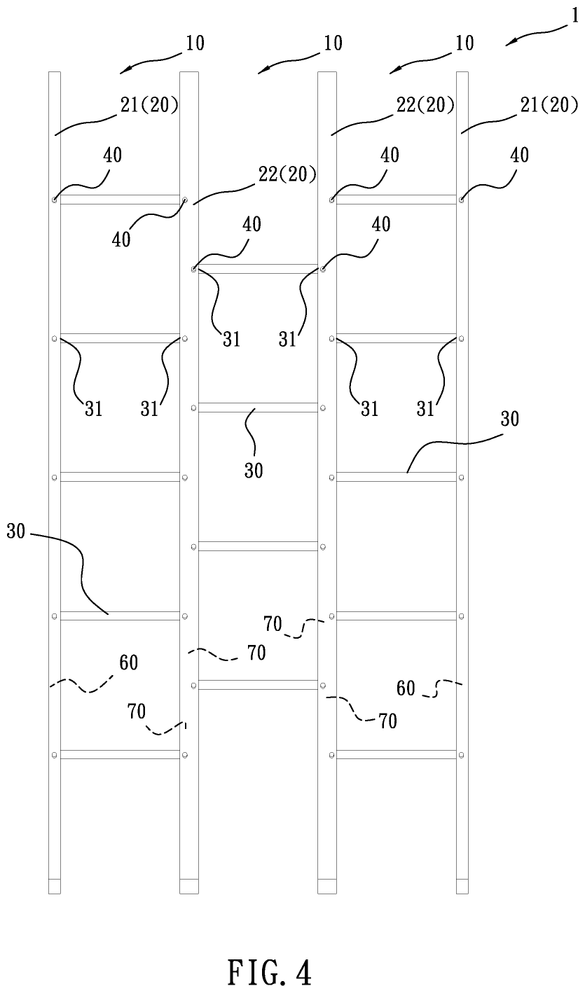

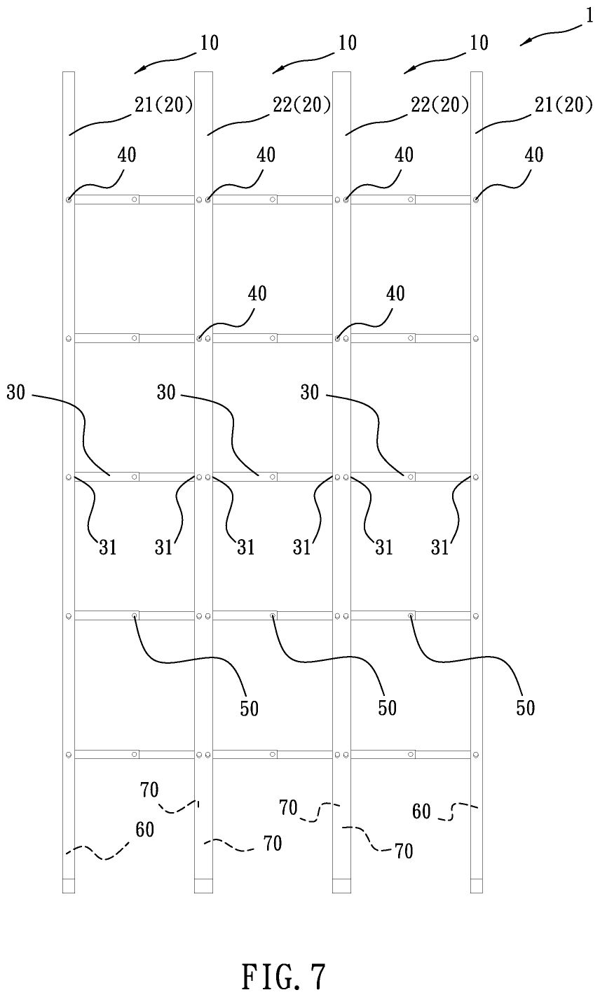

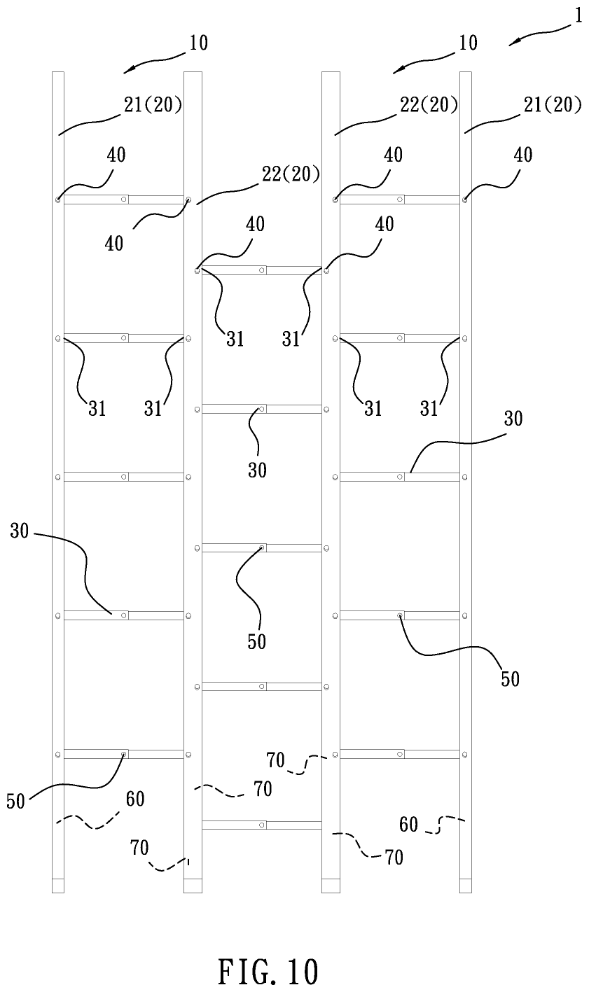

While the two adjacent rails 20 in the first collapsed state are extended horizontally, each rung 30 of the respective ladder frame 10 are rotated and extended by the first pivot shafts 40 on the two ends 31 thereof to form an extended state, as shown in FIG. 1, FIG. 4, FIG. 7 and FIG. 10.

Moreover, the two ladder frames 10 can be extended synchronously to expand the width (range) of the ladder, as shown in FIG. 1, FIG. 4, FIG. 7 and FIG. 10. Or only one of the ladder frames 10 is selected and opened fully to form the horizontally extendable ladder 1 in the extended state and having the width (range) of the single frame 10 (not shown in figure).

Refer from FIG. 7 to FIG. 12, the horizontally extendable ladder 1 further includes a plurality of second pivot shafts 50 each of which is set on a middle part of the respective rung 30 of the ladder frame 10. Thus the respective rung 30 can be rotated and retracted between the two adjacent rails 20 by the first pivot shafts 40 and the second pivot shaft 50, and further folded into a second collapsed state, as shown in FIG. 9 and FIG. 12.

Refer to FIG. 1, FIG. 7 and FIG. 13-18, a vertical slot 60 is disposed on each of the two outer rails 21 among the three rails 20 and an opening of the vertical slot 60 is facing the respective rung 30 between the two rails 20. The first pivot shaft 40 on each of the two ends 31 of the rung 30 is arranged at a front wall and a rear wall of the vertical slot 60. The front wall hereafter is referred to the wall on one side of the extendable ladder 1 where users climb. The middle rail 22 of the three rails 20 is further provided with two slots 70 that are oppositely oriented and openings of the slots 70 are facing the rungs 30 between the two adjacent rails 20(21, 22) respectively. The first pivot shaft 40 on each of the two ends 31 of the rung 30 is arranged at a front wall and a rear wall of the slot 70. As shown in FIG. 3, FIG. 6, FIG. 9, and FIG. 12, the two adjacent rails 20 are able to be moved toward each other and held together and the respective rung 30 is able to be mounted in the slot 60, 70 after the respective rung 30 being rotated and folded between the two adjacent rails 20 to be in the first collapsed state/or the second collapsed state by rotation of the first pivot shafts 40 or the second pivot shaft 50. The respective frame 10 is easy to fold flat for storage.

Furthermore, the rungs 30 of the two adjacent ladder frames 10 can be arranged linearly along the same horizontal line, as shown in FIG. 1-3 or FIG. 7-9, or arranged in parallel, as shown in FIG. 4-6 or FIG. 10-12, or a combination thereof

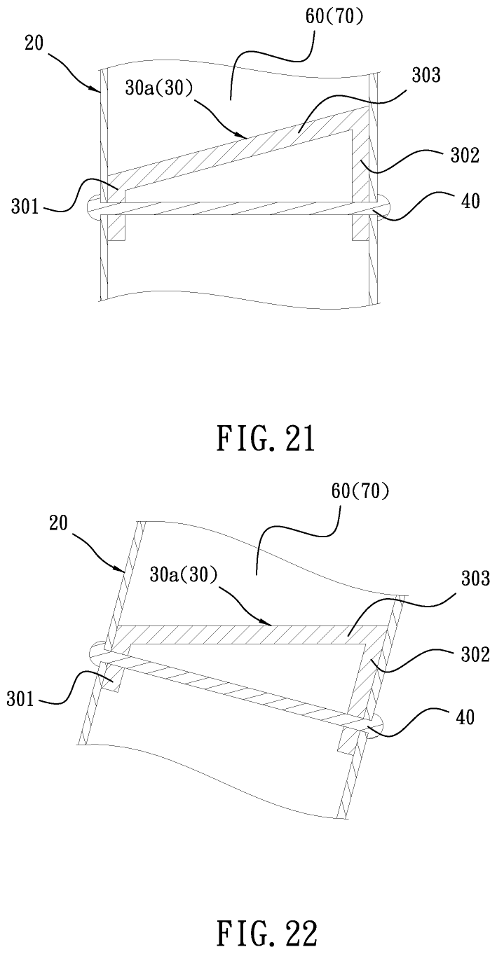

Refer to FIG. 21 and FIG. 22, the respective rung 30 of the ladder frame 10 is designed into an inclined rung 30a having a reverse U-shaped section and composed of a shorter front support 301, a longer rear support 302 and a ramp 303 tilted down. The length of the rear support 302 is longer than that of the front support 301 while the ramp 303 is arranged between a top of the front support 301 and a top of the rear support 302 and used as a stepped surface allowing users to step thereon. The ramp 303 is tilted and a forward tilt angle is formed between the ramp 303 of the inclined rung 30a and the ground when the rails 20 of the respective ladder frame 10 are vertically set on the ground, as shown in FIG. 21. The ramp 303 of the inclined rung 30a is parallel to the ground so that users can step thereon conveniently when the rails 20 of the ladder frame 10 are inclined at an angle and placed on the ground (such as the horizontally extendable ladder 1 is leaned against the wall).

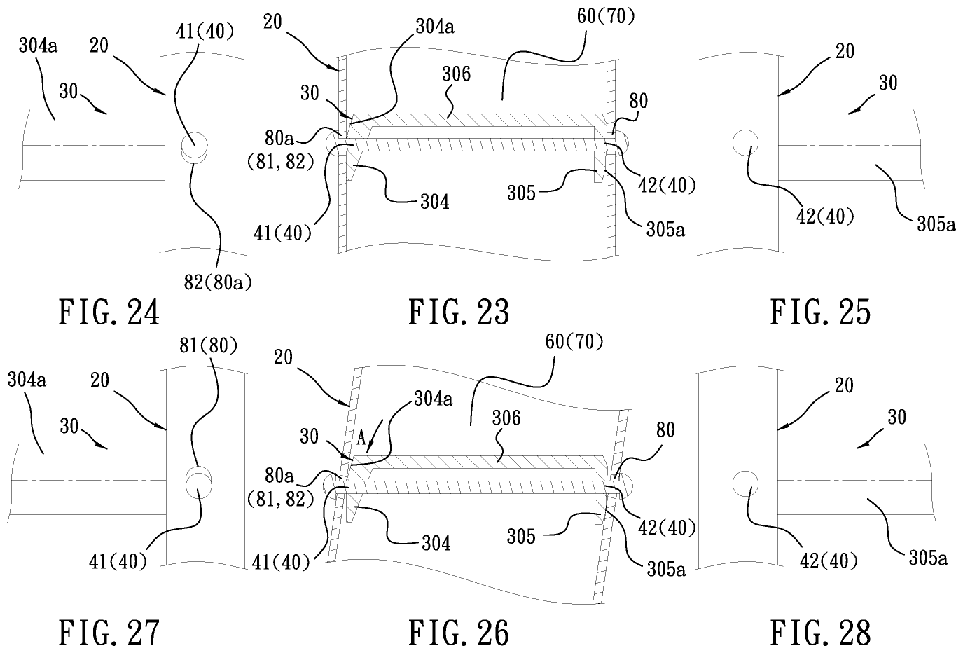

Refer to FIG. 23-28, for pivotally connecting the first pivot shaft 40 to a front wall and a rear wall of the vertical slot 60 (70) of the respective rail 21 (22), a front pivot hole 80a is formed on the front wall of the vertical slot 60 (70) and a rear pivot hole 80 is set on the rear wall of the vertical slot 60 (70). A front end 41 and a rear end 42 of the first pivot shaft 40 are pivotally connected to the front pivot hole 80a an d the rear pivot hole 80 respectively. The front pivot hole 80a is a gourd-shaped hole formed by an upper hole 81 and a lower hole 82 communicating with the upper hole 82. The upper hole 81 and the rear pivot hole 80 are at the same horizontal level of the respective rail 21, 22, as shown in FIG. 23-25. Thus the front end 41 of the respective first pivot shaft 40 can be moved vertically in the front pivot hole 80a to be located in the upper hole 81 or the lower hole 82, as shown in FIG. 24 and FIG. 27. Refer to FIG. 23-25, when the front end 41 of the first pivot shaft 40 of each rung 30 is located in the upper hole 81 of the front pivot hole 80a and the rear end 42 is located in the corresponding rear pivot hole 80, the respective rung 30 can be rotated and folded synchronously between the two adjacent rails 20 to form the first collapsed state or the second collapsed state. Refer to FIG. 26-28, the front end of the first pivot shaft 40 of the respective rung 30 is moved downward from the upper hole 81 of the front pivot hole 80a to the lower hole 82 of the front pivot hole 80a when the respective rail 20 of the respective ladder frame 10 is inclined at an angle and set on the ground and the respective rung 30 is stepped by users (in the direction of the arrow A in FIG. 26). Thereby the stepped surface of the respective rung 30 is parallel to the ground, allowing users to step thereon conveniently.

Refer to FIG. 23 and FIG. 26, the respective rung 30 further includes a reverse U-shaped section formed by a front support 304, a rear support 305 and a stepped surface 306 connected between the top of the front support 304 and the top of the rear support 305. A bevel face 304a is disposed on a front surface of the front support 304 while a bevel face 305a is arranged at a rear surface of the rear support 305. Thereby the front end 41 of the first pivot shaft 40 of the respective rung 30 is moved downward from the upper hole 81 to the lower hole 82 of the front pivot hole 80a and turned back in the opposite direction smoothly. By the design of the bevel faces 304a, 305a, the respective rung 30 will not be stopped by the front wall and the rear wall of the vertical slot 70 during the movement.

The rail 20 and the rung 30 of the present invention can be produced by aluminum extrusion. Thus the ladder features on light weight and high rigidity.

In summary, the present ladder has the following advantages:
1. The present ladder includes at least two ladder frames 10. Users can extend the two ladder frames 10 synchronously or only one ladder frame 10 selectively according to their needs. Thus the operational efficiency is improved.
2. The present ladder includes at least two ladder frames 10 so that the ladder allows at least two users to climb at the same time. Thereby the efficiency of the ladder is increased.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A horizontally extendable ladder comprising:
at least two ladder frames that includes
at least three rails having two outer rails and a middle rail set between the two outer rails, and
a plurality of rungs disposed between the two adjacent rails;
wherein the rungs are equally spaced and arranged horizontally between the two adjacent rails from top to bottom; thereby the ladder frame is formed by the two adjacent rails and the rungs arranged between the two adjacent rails; a first pivot shaft is set on each of two ends of the rung and is pivotally connected to the rail so that the rung is able to be rotated synchronously between the two adjacent rails;
wherein the rung of the ladder frame is able to be rotated and folded between the two adjacent rails by the first pivot shafts on the two ends thereof to form a first collapsed state;
wherein the two adjacent rails are able to be moved close to each other and held together so as to reduce width and area of the ladder frame when the rung of the ladder frame is in the first collapsed state;
wherein the rung of the ladder frame is rotated and extended between the two adjacent rails by the first pivot shafts on the two ends thereof to form an extended state when the two adjacent rails in the first collapsed state are extended horizontally;
wherein the two ladder frames are able to be extended synchronously to form the horizontally extendable ladder in an extended state with extended width and area of the two ladder frame; or only one of the ladder frames is opened selectively and fully to form the horizontally extendable ladder in an extended state with width and area of the single ladder frame.

2. The device as claimed in claim 1, wherein a second pivot shaft is disposed on a middle part of the rung of the ladder frame so that the rung is able to be rotated and retracted between the two adjacent rails by the first pivot shafts and the second pivot shaft, and further folded into a second collapsed state.

3. The device as claimed in claim 1, wherein a vertical slot is disposed on each of the two outer rails of the three rails and an opening of the vertical slot is facing the rung between the two rails; the first pivot shaft on each of the two ends of the rung is arranged at a front wall and a rear wall of the vertical slot; wherein the middle rail of the three rails is further provided with two vertical slots that are oppositely oriented and openings of the vertical slots are facing the rungs between the two adjacent rails; the first pivot shaft on each of the two ends of the rung is arranged at a front wall and a rear wall of the vertical slot; wherein the two adjacent rails are able to be moved toward each other and held together and the rungs are able to be mounted in the slots after the rungs being rotated and folded between the two adjacent rails to be in the first collapsed state by synchronous rotation of the first pivot shafts.

4. The device as claimed in claim 2, wherein a vertical slot is disposed on each of the two outer rails of the three rails and an opening of the vertical slot is facing the rung between the two rails; the first pivot shaft on each of the two ends of the rung is arranged at a front wall and a rear wall of the vertical slot; wherein the middle rail of the three rails is further provided with two vertical slots that are oppositely oriented and openings of the vertical slots are facing the rungs between the two adjacent rails; the first pivot shaft on each of the two ends of the rung is arranged at a front wall and a rear wall of the vertical slot; wherein the two adjacent rails are able to be moved toward each other and held together and the rungs are able to be mounted in the slots after the rungs being rotated and folded between the two adjacent rails to be in the second collapsed state by synchronous rotation of the second pivot shafts.

5. The device as claimed in claim 1, wherein the rungs of the two adjacent ladder frames are arranged linearly along the same horizontal line or in parallel.

6. The device as claimed in claim 1, wherein the rung of the ladder frame is an inclined rung having a reverse U-shaped section and composed of a shorter front support, a longer rear support and a ramp that is tilted down, arranged between a top of the front support and a top of the rear support, and used as a stepped surface; the ramp is tilted and a forward tilt angle is formed between the ramp of the rung and the ground when the rails of the ladder frame are vertically set on the ground; the ramp of the rung is parallel to the ground when the rails of the ladder frame are inclined and placed on the ground so that users can step on the rung conveniently.

7. The device as claimed in claim 5, wherein the rung of the ladder frame is an inclined rung having a reverse U-shaped section and composed of a shorter front support, a longer rear support and a ramp that is tilted down, arranged between a top of the front support and a top of the rear support, and used as a stepped surface; the ramp is tilted and a forward tilt angle is formed between the ramp of the rung and the ground when the rails of the ladder frame are vertically set on the ground; the ramp of the rung is parallel to the ground when the rails of the ladder frame are inclined and placed on the ground so that users can step on the rung conveniently.

8. The device as claimed in claim 3, wherein a front pivot hole is formed on the front wall of the vertical slot and a rear pivot hole is set on the rear wall of the vertical slot when the first pivot shaft on each of the two ends of the rung is arranged at the front wall and the rear wall of the vertical slot of the rail; a front end and a rear end of the first pivot shaft are pivotally connected to the front pivot hole an d the rear pivot hole respectively; the front pivot hole is a gourd-shaped hole including an upper hole and a lower hole communicating with the upper hole; the upper hole and the rear pivot hole are at the same horizontal level of the rail so that the front end of the first pivot shaft is able to be moved vertically in the front pivot hole to be located in the upper hole or the lower hole; the rung is able to be rotated and folded synchronously between the two adjacent rails to form the first collapsed state or the second collapsed state when the front end of the first pivot shaft of the rung is located in the upper hole of the front pivot hole and the rear end is located in the corresponding rear pivot hole; the front end of the first pivot shaft of the rung is moved downward from the upper hole of the front pivot hole to the lower hole of the front pivot hole when the rails of the ladder frame are inclined at an angle and set on the ground;
thereby a stepped surface of the rung is parallel to the ground, able to be stepped thereon conveniently.

9. The device as claimed in claim 4, wherein a front pivot hole is formed on the front wall of the vertical slot and a rear pivot hole is set on the rear wall of the vertical slot when the first pivot shaft on each of the two ends of the rung is arranged at the front wall and the rear wall of the vertical slot of the rail; a front end and a rear end of the first pivot shaft are pivotally connected to the front pivot hole an d the rear pivot hole respectively; the front pivot hole is a gourd-shaped hole including an upper hole and a lower hole communicating with the upper hole; the upper hole and the rear pivot hole are at the same horizontal level of the rail so that the front end of the first pivot shaft is able to be moved vertically in the front pivot hole to be located in the upper hole or the lower hole; the rung is able to be rotated and folded synchronously between the two adjacent rails to form the first collapsed state or the second collapsed state when the front end of the first pivot shaft of the rung is located in the upper hole of the front pivot hole and the rear end is located in the corresponding rear pivot hole; the front end of the first pivot shaft of the rung is moved downward from the upper hole of the front pivot hole to the lower hole of the front pivot hole when the rails of the ladder frame are inclined at an angle and set on the ground; thereby a stepped surface of the rung is parallel to the ground, able to be stepped thereon conveniently.

10. The device as claimed in claim 8, wherein the rung of the ladder frame having a reverse U-shaped section is composed of a shorter front support, a longer rear support and a stepped surface connected between a top of the front support and a top of the rear support for being stepped thereon; a bevel face is disposed on a front surface of the front support while a bevel face is arranged at a rear surface of the rear support; thereby the front end of the first pivot shaft of the rung is moved downward from the upper hole to the lower hole of the front pivot hole and turned back in the opposite direction smoothly.

11. The device as claimed in claim 9, wherein the rung of the ladder frame having a reverse U-shaped section is composed of a shorter front support, a longer rear support and a stepped surface connected between a top of the front support and a top of the rear support for being stepped thereon; a bevel face is disposed on a front surface of the front support while a bevel face is arranged at a rear surface of the rear support; thereby the front end of the first pivot shaft of the rung is moved downward from the upper hole to the lower hole of the front pivot hole and turned back in the opposite direction smoothly.

12. The device as claimed in claim 1, wherein the rail and the rung are produced by aluminum extrusion.
